(19) United States
(12) Patent Application Publication
(10) Pub. No.: US 2004/0227993 A1
(43) Pub. Date: Nov. 18, 2004

(54) Binocular image display

(76) Inventors: Takahiro Amanai, Sagamihara-Shi (JP); Takayoshi Togino, Tokyo (JP)

Correspondence Address: KENYON & KENYON, Suite 700, 1500 K Street, N.W., Washington, DC, 20005, US

(21) Appl. No.: 10/436,246

(22) Filed: May 13, 2003

(51) Int. Cl. G02B 27/02

(52) U.S. Cl. 359/480; 359/630

(57) ABSTRACT

The invention relates to a binocular image display system which can follow changes in the viewing position of a viewer, if any, without superposition of the right-eye pupil and the left-eye pupil, so that the viewer can view 3D images, etc. The image display system comprises an image display device 3, an illumination light source 4, an illumination optical system, a relay optical system 31 and an eyepiece optical system 32. The image display device 3 is a single device adapted to display left-eye and right-eye images alternately. The illumination light source 4 comprises a light source that is changed over to separate illumination areas depending on the displayed left-eye and right-eye images so that the illumination areas can be moved. The exit pupil comprises a pair of left and right exit pupils 1L and 1R determined depending on the illumination areas of the illumination light source. The illumination areas are moved in such a way that the pair of left and right exit pupils 1L and 1R are substantially in line with the positions of the left and right eyeballs of the viewer detected by an eyeball position detector 40 operable to detect the positions of the left and right eyeballs of the viewer.

### BACKGROUND OF THE INVENTION

The present invention relates generally to a binocular image display system, and more particularly to an easy-to-carry and small image display system wherein binocular images appearing on an image display device are guided to both eyes so that 3D images or the like are viewable.

Among compact display systems, there is a direct-viewing type liquid crystal display system. These compact display systems, for the most part, are used with cellular phones and portable terminals. For high-definition display purposes, on the one hand, display systems comprising an increased number of pixels are needed. For moving image display purposes, on the other hand, display systems having fast display speeds are required. Such requirements are satisfied by use of active matrix liquid crystals. However, the active matrix liquid crystals are expensive, and consume large power with the need of large capacity batteries for presenting displays over an extended period of time.

Some arrangements using a small display device and designed to present images appearing on that display device on a magnified scale through an optical system are disclosed in JP-A 48-102527, and JP-A 5-303054 filed by the applicant. In these arrangements, the images appearing on the display systems are magnified through a concave mirror and displayed as virtual images. In the latter arrangement in particular, a non-rotationally symmetric reflecting surface is used to obtain projected images with reduced aberrations.

There is also available a projection optical system proposed by the applicant in JP-A's 5-303055 and 2000-221440. In this projection optical system, an image displayed on a display device is once projected in midair to form a projected image. Then, the projected image is magnified by means of a concave mirror for display purposes.

Display systems, for instance, are disclosed in JP-A's 7-270781 and 9-139901.

Further, the applicant has already filed Japanese Patent Application No. 2001-66669 to come up with a compact, low power consumption display system. In this display system, a relay optical system and an eyepiece optical system are used to set up an optical system. In this optical system, the relay optical system comprises a decentered prism optical system. Then, an image or its intermediate image (hereinafter called simply the image) is projected near the eyepiece optical system. The eyepiece optical system also serves to converge a light beam from the relay optical system toward the eyeball of an observer. At this time, the eyepiece optical system projects the exit pupil of the relay optical system onto a given position. Here the given position is understood to mean the position of the eyeball of the observer upon observation.

JP-A 9-5670 discloses an arrangement wherein binocular parallax images displayed sequentially on one display device are entered into the left and right eyes. In this arrangement, a surface light source is used as a backlight, and areas of the surface light source commensurate to the left and right eyes are illuminated in alignment with the images displayed.

Suppose here that an optical system comprising a relay optical system and an eyepiece optical system is used to set up an image display system capable of viewing images with both eyes. When this image display system is used to view 3D images with both eyes, an image under observation provides a double image upon superposition of right-eye and left-eye exit pupils that are viewable areas. This holds true both when left-eye and right-eye images are sequentially displayed on one display device, and when left-eye and right-eye images are simultaneously displayed on a pair of left and right display devices.

### SUMMARY OF THE INVENTION

The present invention provides a binocular image display system, comprising:

an image display device for displaying an image,

an illumination light source for generating illumination light, wherein said illumination light source comprises a plurality of illumination areas provided in such a way as to be variable,

an illumination optical system for directing illumination light from said illumination light source toward said image display device,

a relay optical system for projection of an image appearing on said image display device,

an eyepiece optical system for converging a light beam from said relay optical system at a given position,

an eyeball position detector for detecting the positions of both eyeballs of a viewer, and

a control unit for varying said illumination areas based on information on the positions of both eyeballs of a viewer detected by said detector.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative in perspective of one fundamental arrangement of the binocular image display system according to the invention.

FIG. 2 is illustrative in more details of the action of the binocular image display system of the invention.

FIG. 3 is illustrative in schematic and perspective of the construction of the binocular image display system wherein the relay optical system comprises a single decentered prism.

FIG. 4 is illustrative in schematic and perspective of the construction of the binocular image display system wherein the relay optical system comprises a pair of decentered prisms.

FIG. 5 is illustrative in schematic and perspective of the single decentered prism forming part of the relay optical system, and how to locate the illumination light source and introduce illumination light when the image display device used is of the reflection type.

FIG. 6 is illustrative of the exit pupils, each in an elliptical shape having a long transversal major diameter.

FIGS. 7(a) and 7(b) are illustrative of diffusion in the horizontal and vertical directions, respectively, showing the diffusibility of the diffusing optical surface located in the eyepiece optical system.

FIG. 8 is illustrative in schematic and perspective of the binocular image display system of the invention, constructed in the form of a hand-holdable viewer type.

FIG. 9 is an optical path diagram for Example 1 of the optical system as projected onto a Y-Z plane from one light source toward one exit pupil.

FIG. 10 is an optical path diagram for Example 1 of the optical system as projected onto an X-Z plane.

FIG. 11 is an optical path diagram for Example 1 of the optical system as projected onto an X-Z plane from both light sources toward both exit pupils.

FIG. 12 is an enlarged view of the vicinities of the light sources, illumination optical system, image display device and decentered prism of the relay optical system in FIG. 11.

FIG. 13 is an image-formation optical path diagram corresponding to FIG. 9.

FIG. 14 is an image-formation optical path diagram corresponding to FIG. 10.

FIG. 15 is an optical path diagram for Example 2 of the optical system as projected onto a Y-Z plane from one light source toward one exit pupil.

FIG. 16 is an optical path diagram for Example 2 of the optical system as projected onto an X-Z plane.

FIG. 17 is an optical path diagram for Example 2 of the optical system as projected onto an X-Z plane from both light sources toward both exit pupils.

FIG. 18 is an optical path diagram for Example 3 of the optical system as projected onto a Y-Z plane from one light source toward one exit pupil.

FIG. 19 is an optical path diagram for Example 3 of the optical system as projected onto an X-Z plane.

FIG. 20 is an optical path diagram for Example 3 of the optical system as projected onto an X-Z plane from both light sources toward both exit pupils.

FIG. 21 is an enlarged view of the vicinities of the light sources, illumination optical system, image display device and decentered prism of the relay optical system in FIG. 20.

FIG. 22 is a transverse aberration diagram for one optical system in Example 1.

FIGS. 23(a) and 23(b) are illustrative of one exemplary illumination light source; FIG. 23(a) is illustrative of how the center to left area emits light, and FIG. 23(b) is illustrative of how the center to right area gives out light.

FIGS. 24(a) and 24(b) are illustrative of another exemplary illumination light source; FIG. 24(a) is illustrative of how the center to left area emits light, and FIG. 24(b) is illustrative of how the center to right area gives out light.

### DESCRIPTION OF THE PREFERRED EMBODIMENTS

The principles and embodiments of the binocular image display system according to the invention are now explained.

The fundamental arrangements of the binocular image display system according to the invention are first explained.

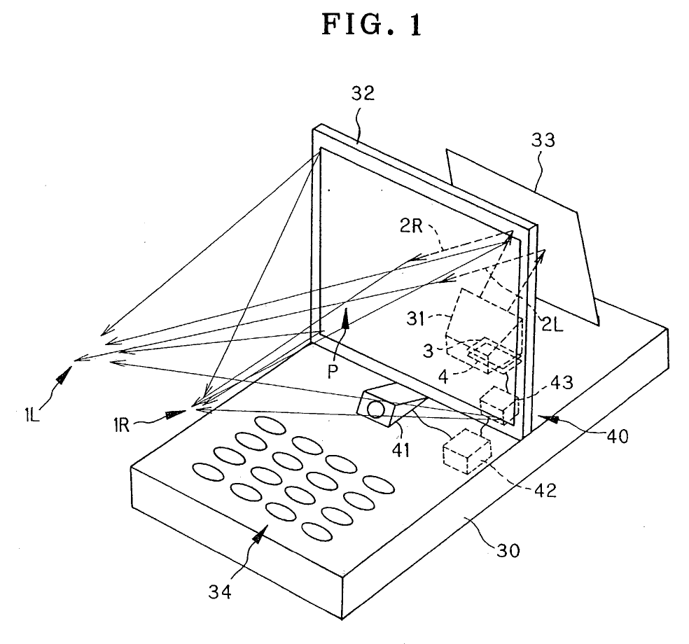

One basic arrangement of the binocular image display system according to the invention is shown in FIG. 1. Referring to FIG. 1, a relay optical system 31 is located on a system body 30. The relay optical system 31 is provided on its bottom side, i.e., its side that faces the system body 30, with a single or a pair of image display devices 3. The position of the image display device 3 corresponds to the object point position of the relay optical system 31.

The arrangement of FIG. 1 is presumed to rely on the single image display device. The image display device 3 is of the transmission type.

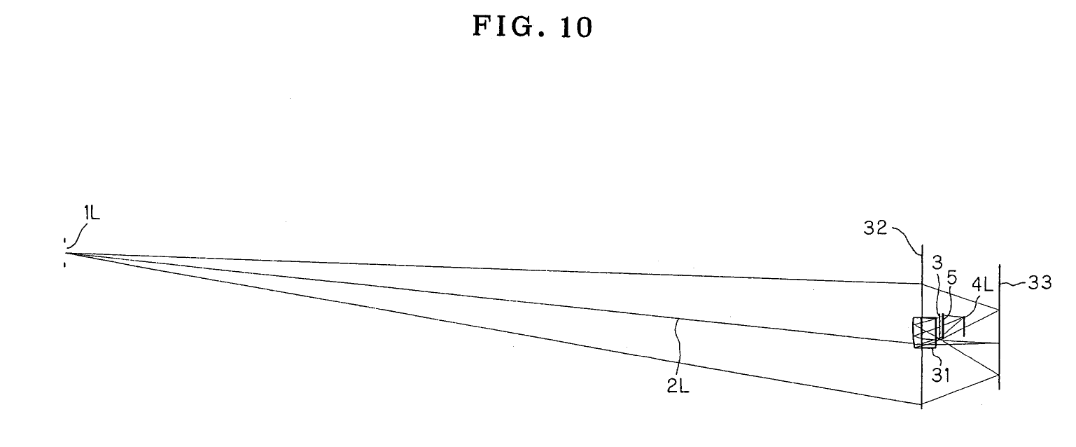

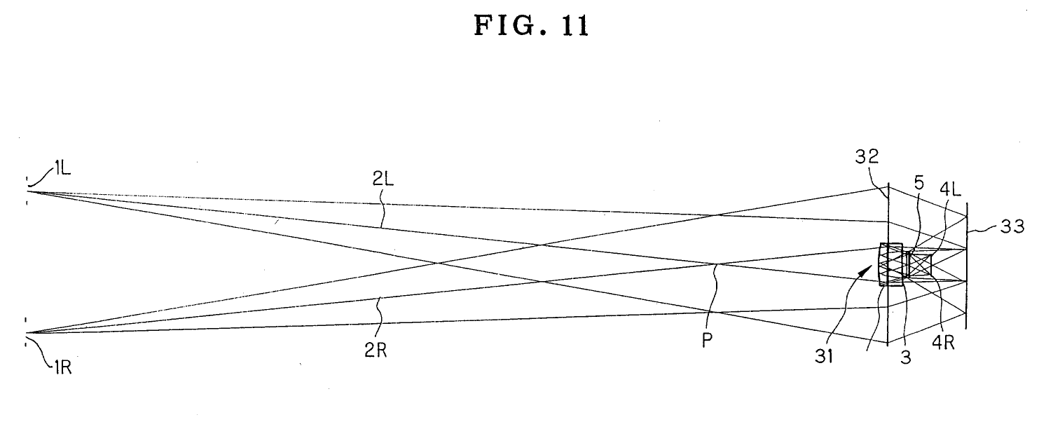

An illumination light source 5 (not shown) and an illumination light source 4 comprising a surface light source are located across and in opposition to the bottom of the image display device 3. For the illumination optical system 5, see FIGS. 10, 11 and 12.

A reflecting surface (plane mirror) 33 is located in opposition to the surface of the relay optical system 31 which light rays leave, and an eyepiece optical system 32 having positive power is located in opposition to the reflecting surface with the relay optical system 32 interposed between them.

Thus, illumination light leaving the illumination light source 4 is directed through the illumination optical system 5 to light the image display device 3. Light from the image display device 3 enters the relay optical system 31, and then leaves the relay optical system 31, traveling toward the reflecting surface 33. At this time, the light leaving the relay optical system 31 propagates along two optical axes 2L and 2R. Light reflected at the reflecting surface 33 travels toward the eyepiece optical system 32. Transmitting through the eyepiece optical system 32, the light arrives at exit pupils 1L and 1R formed at given positions.

It is here noted that the left and right exit pupils 1L and 1R are optically conjugate to the illumination light source 4, so that if the eyes of the viewer are in line with the exit pupils 1L and 1R, the illumination light from the illumination light source 4 can then enter the eyes of the viewer. At this time, the illumination light has passed through the image display device 3; the light of an image appearing on the image display device 3 enters the eyes of the viewer, so that the viewer can view the image appearing on the display image device 3.

Thus, the illumination light leaving the illumination light source 4 is modulated at the image display device 3, and thereafter propagates along the left and right optical axes 2L and 2R via the relay optical system 31 and eyepiece optical system 32. Then, this illumination light (modulated light) is projected onto the left and right exit pupils 1L and 1R of the image display device, so that the illumination light can be projected onto both eyes without any loss and a bright, efficient 3D image can be magnified and displayed.

It is noted that operating buttons 34 are located on the body 30 of the display system in front of the relay optical system 31 as viewed from the viewer side, so that each button 34 can be manipulated without blocking an optical path and, hence, it is unlikely that the image is obstructed each time the button is manipulated.

For the above reasons, it is of importance that the positions of both eyes of the viewer be in line with the exit pupils 1L and 1R. In other words, if the positions of both eyes of the viewer are out of place, a portion of the light beam does not enter the eyes. Consequently, when the image under observation becomes dark, it is then impossible to observe a part of the image under observation. To avoid this, an eyeball position detector 40 is provided in the invention. This eyeball position detector 40 has a function of detecting the positions of the left and right eyeballs of the viewer.

In the invention, the positions of the left and right eyeballs of the viewer are detected by means of the eyeball position detector 40 that comprises an imaging device 41, an image processor 42 and a controller 43.

The imaging device 41 picks up an image of the face of the viewer. The image processor 42 performs image processing for identifying the positions of the eyeballs after obtaining an eyeball image from the thus picked up image. The controller 43 controls the illumination light source 4 on the basis of eyeball position information obtained at the image processor 42.

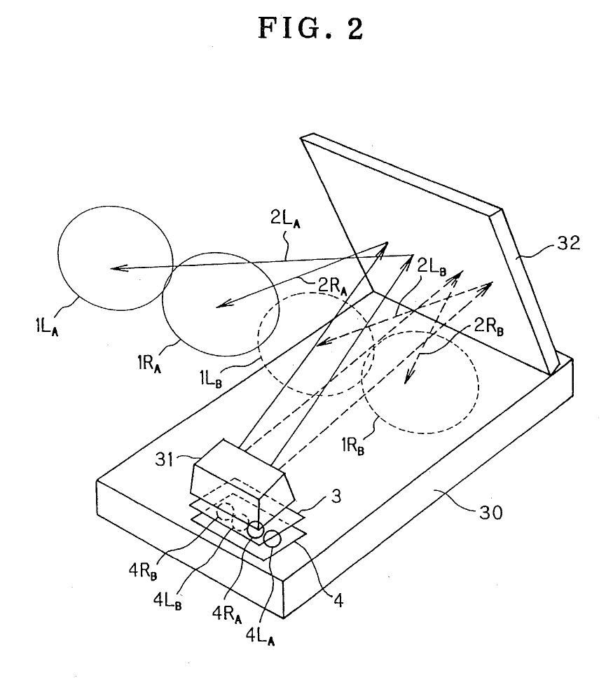

The action of the eyeball position detector 40 is now explained in a little more detail with reference to FIG. 2.

In FIG. 2, the eyeball position detector 40 is not illustrated unlike in FIG. 1. The eyepiece optical system 32 illustrated is of the reflection type; however, it is essentially of the same construction as that of FIG. 1, although the eyepiece optical system of FIG. 1 is of the transmission type.

As shown in FIG. 2, an illumination light source 4 that is a surface light source comprises light-emitting (illumination) areas 4L_{A}, 4R_{A} and 4L_{B}, 4R_{B}. When illumination light is emitted out of light-emitting areas 4L_{A} and 4R_{A}, the optical axis of illumination light is given by 2L_{A} and 2R_{A} and so exit pupils are given by 1L_{A} and 1R_{A}. On the other hand, when illumination light is emitted out of light-emitting areas 4L_{B} and 4R_{B}, the optical axis of illumination light is given by 2L_{B} and 2R_{B}. Accordingly, as the light-emitting areas change from 4L_{A}, 4R_{A} to 4L_{B}, 4R_{B}, the optical axis changes from 2L_{A}, 2R_{A} to 2L_{B}, 2R_{B}. Correspondingly, the left and right exit pupils change from 1L_{A}, 1R_{A} to 1L_{B}, 1R_{B}.

By changing the left and right light-emitting areas 4L, 4R (4L_{A}, 4R_{A}; 4L_{B}, 4R_{B}) of the illumination light source 4, it is thus possible to shift the positions of the left and right exit pupils 1L, 1R (1L_{A}, 1R_{A}; 1L_{B}, 1R_{B}). Therefore, if the positions of the left and right eyeballs of the viewer are detected and the left and right light-emitting areas 4L, 4R of the illumination light source 4 are changed on the basis of the obtained information as described above, it is then possible to bring the positions of the left and right exit pupils 1L and 1R in line with the positions of the eyeballs of the viewer. As a consequence, even when there is a change in the viewing position of the viewer, it is always possible to observe bright, shading-free 3D images.

According to one possible approach to changing the light-emitting areas 4L and 4R, light is emitted out of a portion of the widest possible light-emitting area, and according to another possible approach, a light source having a given small light-emitting area is moved.

In the arrangement of FIG. 1, the eyepiece optical system 32 of the transmission (refraction) type is used; the left and right optical axes 2L and 2R on the exit side of the relay optical system 31 are turned back at the reflecting surface 33, arriving at the positions of the both eyes of the viewer through the eyepiece optical system 32 of the transmission (refraction) type. In the arrangement of FIG. 2, on the other hand, the reflecting surface 33 is not needed because of use of the reflection type of eyepiece optical system 32.

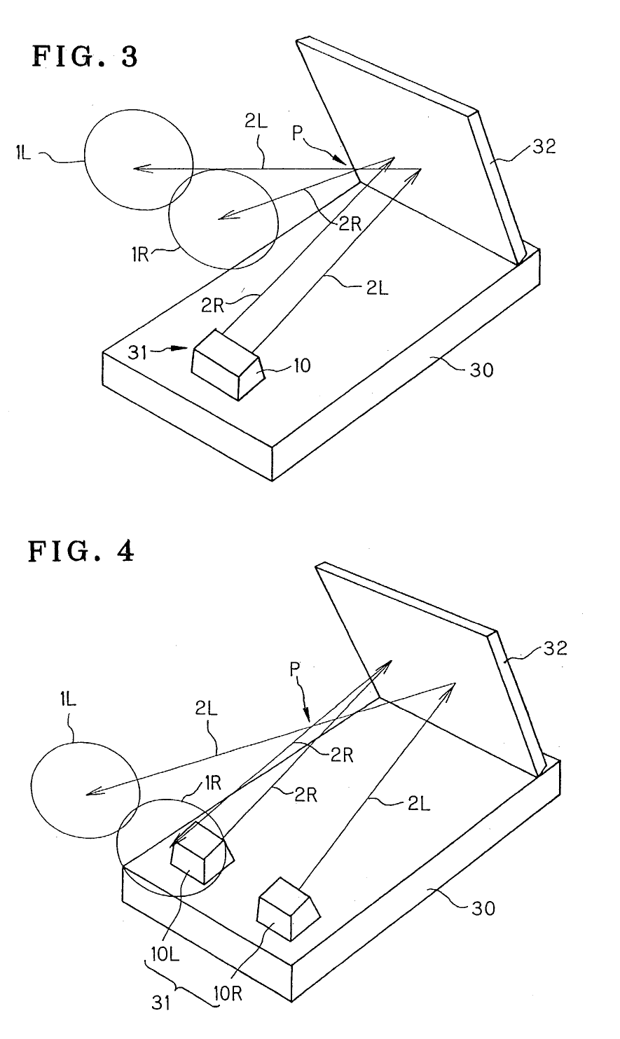

Then, the relay optical system 31 is explained with reference to two possible embodiments comprising a decentered prism or prisms. In one possible embodiment, the relay optical system 31 comprises a single decentered prism 10 as shown in FIG. 3, and in another embodiment, the relay optical system 31 comprises a pair of left and right decentered prisms 10L and 10R having the same configuration, as shown in FIG. 4.

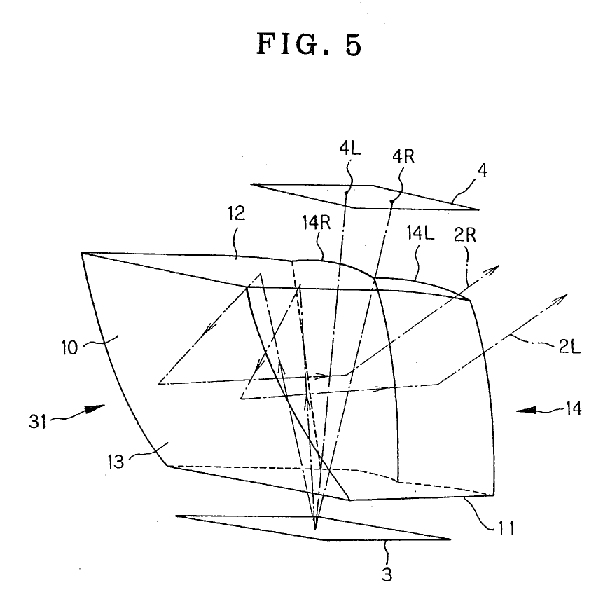

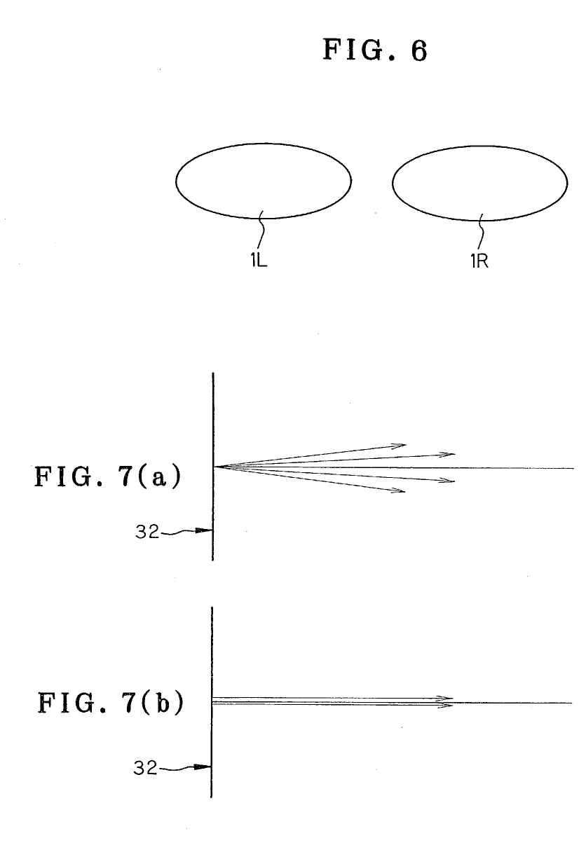

One example of the single decentered prism 10 is schematically shown in FIG. 5. The relay optical system 31 shown in FIG. 5 comprises an entrance surface 11, an exit surface 14 and two internal reflecting surfaces 12, 13. In this arrangement, axial chief rays (corresponding to optical axes) 2L and 2R leaving the image display device 3 arrive at the internal reflecting surface 12 via the entrance surface 11. The axial chief rays 2L and 2R reflected at the internal reflecting surface 12 are then directed toward the internal reflecting surface 13 at which they are reflected, leaving the exit surface 14. Here the internal reflecting surfaces 12 and 13 are designed in such a way as to make an acute angle so that the light ray directing from the entrance surface 11 toward the internal reflecting surface 12 substantially crosses the light ray from the internal reflecting surface 13 toward the exit surface 14 within the decentered prism 10.

The exit surface 14 comprises two adjoining surfaces 14L and 14R with a discontinuous boundary between them. In other words, the exit surface 14 is defined by a discontinuous surface. It is understood that one or more of other optical surfaces 11, 12 and 13 could be defined by such a discontinuous surface comprising two such adjoining surfaces.

In the arrangements of FIGS. 1 and 2, the image display device 3 used is assumed to be of the transmission type. However, if the reflection type image display device 3 is used, the size of the image display arrangement can then be reduced. Commonly, the space between the image display device 3 and the relay optical system 31 is narrow. In this case, the decentered prism 10 can be used as the relay optical system as shown in FIG. 5.

Referring to FIG. 5, the illumination light source 4 is located in opposition to the image display device 3 with the decentered prism 10 interposed between them. This enables the image display device 3 to be illuminated via the internal reflecting surface 12 and entrance surface 11 of the decentered prism 10.

In this arrangement, too, the light-emitting area of the illumination light source 4 could be variable as described above. This allows illumination light from the left and right light-emitting areas 4L and 4R to be directed to the display screen surface of the reflection type image display device 3. Display light modulated at the display screen surface of the image display device 3 reenters the decentered prism 10 forming the relay optical system 31, and so an image on the display screen surface is projected along the optical axes 2L and 2R leading to the left and right exit pupils 1L and 1R.

When the image display device 3 is of the reflection type in the arrangement of FIG. 5, the internal reflecting surface 12 is made up of a half-silvered mirror, so that illumination light coming from the illumination light source 4 via the internal reflecting surface 12 can enter the decentered prism 10. The illumination light entering the decentered prism 10 leaves the prism via the entrance surface 11. This illumination light illuminates the display screen surface of the reflection type image display device 3.

In the arrangement of FIG. 5, the display screen surface is illuminated through some of the surfaces of the decentered prism 10; however, the display screen surface could be illuminated through all the surfaces of the decentered prism 10.

It is noted that FIG. 3 is illustrative of the embodiment of the invention wherein one relay optical system 31 is used; the relay optical system 31 is made up of a single decentered prism 10. In other words, the decentered prism 10 has at least one optical (reflecting or refracting) surface defined by a discontinuous surface comprising two adjoining surfaces, and a single image display device is used as the image display device 3. In that case, images of binocular parallax for the left and right eyes are alternately displayed on the display screen surface.

As shown in FIG. 4, the relay optical system 31 could be made up of two decentered prisms, i.e., a pair of left and right decentered prisms 10L and 10R having the same configuration. Each decentered prism 10L, 10R is provided with an associated image display device 3, so that images of binocular parallax for the left and right eyes can be displayed on the respective display screen surfaces.

For observation of 3D images, an image having binocular parallax is used. This image is projected through the relay optical system 31 onto a given position. Near the position of the projected image there is located an eyepiece optical system 32 that takes part in the formation of left and right exit pupils 1L and 1R.

To this end, the eyepiece optical system 32 is allowed to have an optical surface having diffusibility. The optical surface should then preferably have directivity while some control is exerted on its diffusibility; diffusibility and directivity should be such that the exit pupils 1L and 1R are not coresident or do not overlap. The location of such an optical surface ensures that the light beam traveling toward the exit pupils 1L and 1R can become thick. In turn, this allows the ranges of the exit pupils 1L and 1R to become so wide that the range of viewing images with both eyes can become wide.

The exit pupils 1L and 1R formed by the eyepiece optical system 32 having diffusibility should preferably be of elliptical shape. Then, the major axis direction of the ellipse should preferably be such that the exit pupils 1L and 1R adjoin. To obtain such an ellipse, the diffusibility of the optical surface located in the eyepiece optical system 32 should preferably be determined as shown in FIGS. 7(a) and 7(b). In other words, that optical surface is designed in such a way as to have diffusibility in the horizontal direction (FIG. 7(a)) but have little or no diffusibility in the vertical direction (FIG. 7 (b)). This lets nothing go to waste with regard to the quantity of light, with the result that even when the range of the exit pupils 1L and 1R is wide, images under observation become less dark. In addition, the range of the exit pupils 1L and 1R is wider in both the horizontal and the vertical direction, so that even with some displacement of both eyes from the exit pupils 1L and 1R, it is possible for the viewer to observe bright images.

It is noted that one decentered prism could be used for the relay optical system 31 in the invention or, alternatively, a decentered prism optical system comprising a plurality of such decentered prisms could be used. Each decentered prism has at least one internal reflection.

A typical decentered prism example is given in Example 1, 2, and 3 described later. The decentered prism comprises an entrance surface, two reflecting surfaces, i.e., a first reflecting surface and a second reflecting surface, and an exit surface. Then, an optical path connecting the entrance surface with the first reflecting surface crosses an optical path connecting the second reflecting surface with the exit surface in the prism.

The decentered prism of such configuration has a high flexibility in correction of aberrations or the aberrations produced are limited. In addition, both reflecting surfaces are of so high symmetry with respect to position that aberrations occurring at both reflecting surfaces are canceled out, ending up with limited aberrations. The optical paths cross each other to ensure that the optical path length can be longer as compared with a prism of the structure of turning back an optical path. Thus, the prism size can be reduced relative to the optical path length.

It is noted that the decentered prism 10 such as one shown in FIG. 3 may be constructed of a single decentered prism 10 as follows. Typically, at least one optical (reflecting or refracting) surface is defined by a discontinuous surface comprising two adjoining surfaces, whereby a light beam coming from the image display device 3 is divided into two optical paths.

It is also noted that the binocular image display system of the invention is designed such that the eyepiece optical system 32 and reflecting surface 33 can be opened or closed with respect to the display system body 30. Provision of such an opening/closing mechanism (not shown) enables the display system to be received in a pocket or the like during take-along. An additional function of stopping power supply could contribute greatly to power savings.

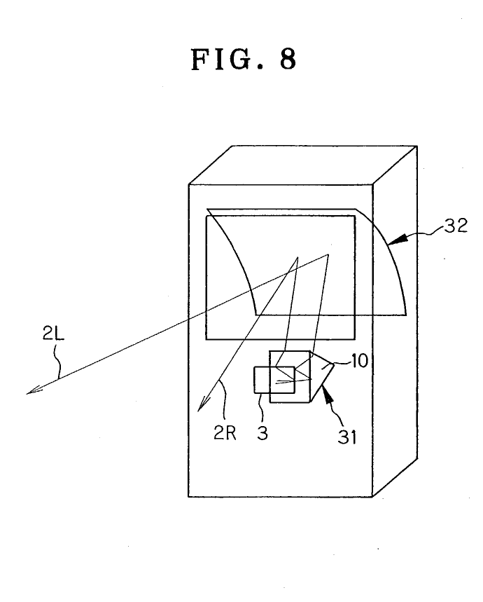

The binocular image display system of the invention could be constructed in the form of not simply the take-along type but also a hand-holdable viewer type as shown in FIG. 8.

In what follows, numerical examples 1, 2 and 3 of the optical system used with the binocular image display system of the invention are given.

Constituent parameters for Examples 1, 2 and 3 will be described later. Referring here to the coordinate system, assume that the Y-Z plane is defined by a plane that is vertical to a straight line connecting the centers of two left and right exit pupils 1L and 1R through the center between the two exit pupils (see FIG. 1) (the viewing pupils) and forms a plane of symmetry of the optical system, and the Z-axis position direction is defined by a direction from the centers of the exit pupils 1L and 1R toward the eyepiece optical system 32.

Also assume that the Y-axis direction is given by a direction orthogonal to the Z-axis direction; the Y-axis negative direction is given by a direction toward the position of the image display device 3; the X-axis direction is given by a direction orthogonal to the Y-Z plane; the X-axis positive direction is given by the direction of the X-axis that forms a right-handed orthogonal coordinate system with the Y- and Z-axes; and the origin of the optical system is given by the apex positions of the surface of the eyepiece optical system 32 on the sides of the exit pupils 1L and 1R.

For the decentered surface, there are given the amount of decentration of its apex from the origin of the optical system and the angles of inclination of its center axis around the X-, Y- and Z-axes (α, β, γ(°)). The center axis is the Z-axis of the aforesaid formula (a) for a free-form surface, and the Z-axis of formula (b) given later for an aspheric surface. In that case, the positive for α and β means counterclockwise rotation with respect to the positive direction of the respective axes, and the positive for γ means clockwise rotation with respect to the positive direction of the Z-axis. For α, β and γ rotation of the center axis of the surface, the center axis of the surface and its XYZ orthogonal coordinate system are first counterclockwise rotated around the X-axis by α. Then, the center axis of the rotated surface is counterclockwise rotated around the Y-axis of a new coordinate system by β while the once rotated coordinate system is counterclockwise rotated around the Y-axis by β. Then, the center axis of the twice rotated surface is clockwise rotated around the Z-axis of a new coordinate system by γ.

The surface shape of the free-form surface used herein, for instance, is defined by formula (a) in U.S. Pat. No. 6,124,989 (JP-A 2000-66105), and the Z-axis of the defining formula (a) gives the axis of the free-form surface.

The aspheric surface is a rotationally symmetric aspheric surface given by the following defining formula:

Z=(y²/R)/[1+{1−(1+K)y²/R²}^{1/2}]+Ay⁴+By⁶+Cy⁸+Dy¹⁰+ . . . (b)

where Z is an optical axis (axial chief ray) provided that the direction of propagation of light is positive, and y is in the direction vertical to the optical axis. Here R is a paraxial radius of curvature, K is a conical constant, and A, B, C, D, . . . are the 4th, 6th, 8th and 10th aspheric coefficients. The Z-axis of this defining formula provides the axis of the rotationally symmetric aspheric surface.

It is noted that the term with respect to the free-form and aspheric surfaces on which no data are given is zero. The refractive index is given with respect to the d-line (587.56 nm wavelength), and the length is given in mm.

Numerical examples 1, 2 and 3 given below are expressed in terms of back ray tracing from the aforesaid one exit pupil 1L toward the image display device 3L.

### EXAMPLE 1

In this example, one pupil has a transversal diameter of 40 mm and a vertical diameter of 15 mm. An image under observation is formed on an eyepiece optical system 32 located 400 mm forward of the pupil position and having a horizontal length of 55 mm and a vertical length of 41.25 mm. Left and right optical axes leave the eyepiece optical system with an inward angle determined such that the left and right optical axes cross each other at a position 320 mm away from the pupil position on the side of the eyepiece optical system 32. For an image display device 3, an 8.94 mm×6.71 mm display device is used.

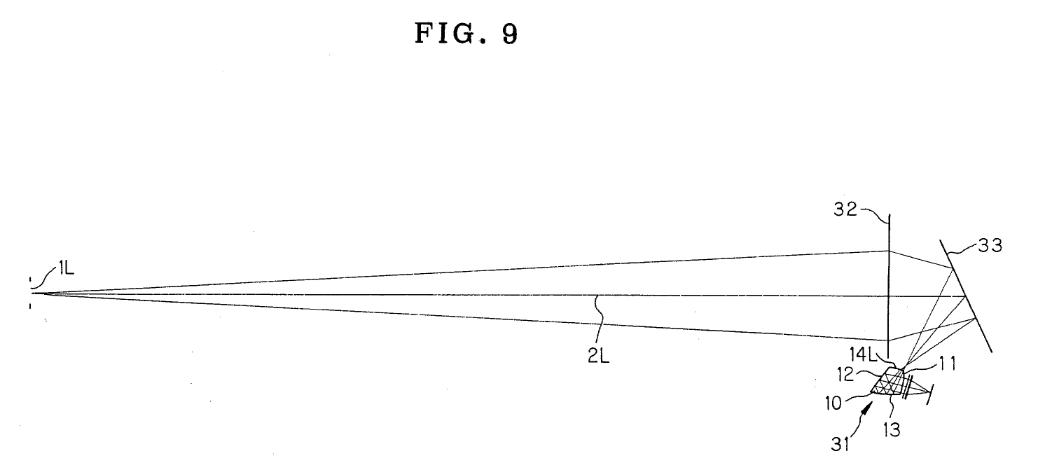

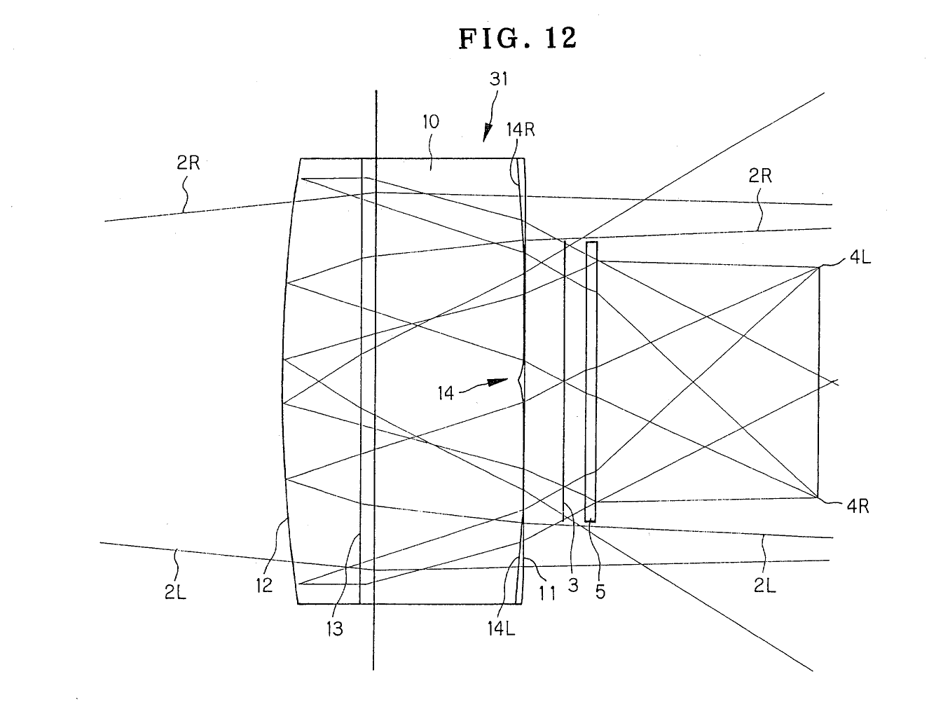

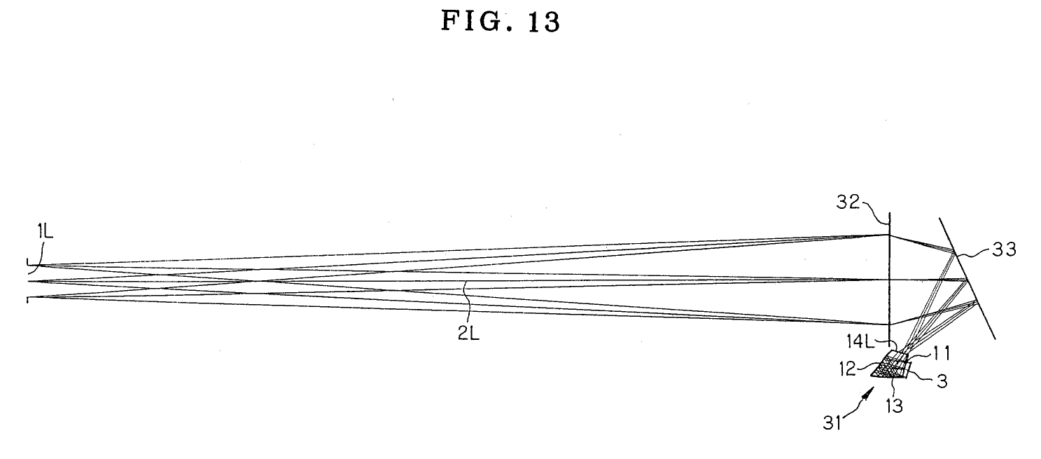

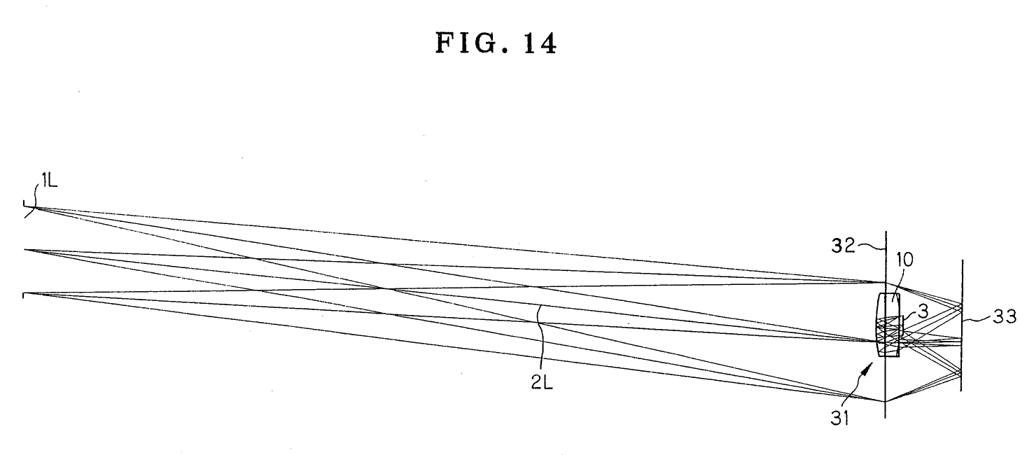

FIG. 9 is an optical path diagram as projected onto a Y-Z plane from one light source (the left illumination area at a reference position) 4L toward one exit pupil 1L; FIG. 10 is an optical path diagram as projected onto an X-Z plane; FIG. 11 is an optical path diagram as projected onto the X-Z plane from both light sources 4L and 4R toward both exit pupils 1L and 1R; and FIG. 12 is an enlarged view of the vicinities of light sources 4L, 4R, illumination optical system 5, image display device 3 and decentered prism 10 of relay optical system 31 in FIG. 11. Image-formation optical path diagrams corresponding to FIGS. 9 and 10 are shown in FIGS. 13 and 14, from which light source 4L and illumination optical system 5 are omitted.

Numerical data given later have been obtained by ray tracing from the left exit pupil 1L to one light source 4L via the image display device 3, and data on the optical system upon ray tracing from the right exit pupil 1R to another light source 4R via the image display device 3 have been obtained at a position symmetrical with respect to the Y-Z plane.

In Example 1, a decentered prism 10 forms a relay optical system 31. The fourth surface 14 of this decentered prism 10 (the fifth surface in the numerical data) comprises a discontinuous surface symmetrical with respect to the Y-Z plane. For this reason, only the surface shape of one surface 14L is shown. This surface 14L takes part in the formation of a left exit pupil 1L, and is located on the X-axis negative side with respect to the Y-Z plane. On the positive side of the X-axis with respect to the Y-Z plane, there is located another surface 14R that is symmetrical with respect to the surface 14L (see FIG. 12).

In this example, the fourth surface 14 is thus formed as a discontinuous surface made up of two optical surfaces 14L, 14R symmetrical with respect to the plane of symmetry, thereby setting up an optical system that forms at given positions left and right exit pupils 1L and 1R, each having a transversal diameter of 40 mm and a vertical diameter of 15 mm. These given positions are mutually spaced 75 mm from the plane of symmetry (Y-Z plane) of the optical system in this example.

Example 1 is directed to an optical system dedicated to the binocular image display system corresponding to the embodiment of FIG. 3, as shown in FIGS. 9-14. An eyepiece optical system 32 that faces the exit pupil 1L (1R) is made up of a Fresnel lens whose surface on the side of the exit pupil 1L (1R) is a Fresnel transmitting surface and whose opposite surface is a plane. On the entrance side of the Fresnel lens, there is located a reflecting surface (plane mirror) 33 for turning back an optical path. In opposition to the reflecting surface 33, there is located a relay optical system 31 that is made up of a decentered prism 10 that faces the image display device 3.

The decentered prism 10 in this example is made up of a first surface 11, a fourth surface 14 and two reflecting surfaces, i.e., a second surface 12 and a third surface 13. The first surface 11 faces the image display device 3, and the fourth surface 14 faces the reflecting surface 33. Both reflecting surfaces or the second and third surfaces 12 and 13 are interposed between the first surface 11 and the fourth surface 14.

As described above, the fourth surface 14 is built up of two surfaces 14L and 14R that form together a discontinuous surface and are symmetrical with respect to the plane of symmetry (Y-Z plane) of the optical system.

The image display device 3 is made up of a transmission type liquid crystal display device. On the side of the image display device 3 that faces away from the relay optical system 31, there is provided an illumination optical system 5 that is a Fresnel lens both surfaces of which are defined by Fresnel transmitting surfaces. This Fresnel lens is positioned near the image display device 3, and in the vicinity of its front focal plane, light sources 4L and 4R are located at positions that are symmetrical with respect to the plane of symmetry (Y-Z plane). The light sources 4L and 4R for illuminating the left and right optical paths, respectively, are located at reference positions.

In the instant example, left-eye and right-eye images having binocular parallax are alternately displayed on the image display device 3. The light sources 4L and 4R for the left and right optical paths are selectively put on in synchronism with the alternate display of those-images, so that the left-eye and right-eye images having parallax can be displayed on the exit pupils 1L and 1R in a time-division fashion. The viewer can then bring his both eyes in line with the exit pupils 1L and 1R, thereby viewing 3D images.

More specifically, light beams from the light sources 4L and 4R enter the illumination optical system 5. The light beams are then collimated through the Fresnel lens into a substantially parallel light beam to light the image display device 3 from behind. As already referred to, the image display device 3 is a transmission type liquid crystal display device; the light beam provides display light upon transmission through the image display device 3, traveling toward the decentered prism 10. Then, the light beam enters the decentered prism 10 upon refraction at the first surface 11 thereof, in which it is subjected to repetitive internal reflections at the second surface 12 and the third surface 13. Then, the reflected light is refracted as separate light beams along the separate optical path at both surfaces 14L and 14R of the fourth surface 14, leaving the prism.

Both light beams leaving the decentered prism 10 are turned back at the reflecting surface 33, following which a magnified image is formed as a double image on the Fresnel lens surface of the eyepiece optical system 32. This magnified image is the left-eye and right-eye image displayed on the image display device 3. Upon incidence on the eyepiece optical system 32, both light beams are refracted thereat, and then converged into the left and right exit pupils 1L and 1R, respectively (the light sources 4L and 4R are conjugate to the exit pupils 1L and 1R). In this case, the left and right optical paths 2L and 2R cross each other at a point P spaced 320 mm away from the positions of the exit pupils 1L and 1R toward the eyepiece optical system 32. For this reason, the magnified image formed on the Fresnel lens surface of the eyepiece optical system 32 is fused near this point P, so that an image appearing on the image display device 3 is seen as if it were three-dimensionally displayed in the air.

As explained with reference to FIGS. 1 and 2, the positions of the left and right eyeballs of the viewer are then detected by means of the eyeball position detector 40. In response to the detected information, the light sources 4L and 4R defining the left and right illumination areas of the light source 4 are so moved that the positions of the left and right exit pupils 1L and 1R can follow the eyeball positions of the viewer. Thus, it is possible for the viewer to view bright, shading-free images even with changes in the viewing position of the viewer. It is also possible to achieve a binocular image display system having a limited number of components and reduced in terms of size and power consumption.

In this example, a lenticular sheet having diffusibility in the horizontal direction is further located near the plane (the third surface in the numerical data) of the eyepiece optical system 32, so that the pupils can be enlarged in the horizontal direction alone and, hence, a much wider viewing range can be assured. Even with some displacement of the eyeballs of the viewer, it is possible for the viewer to observe bright, shading-free images if the eyeballs are within this viewing range.

In this example, free-form surfaces are used for all the first surface 11 through the fourth surface 14 of the decentered prism 10, and an aspheric surface is used for the Fresnel transmitting surface of each of the Fresnel lenses of the eyepiece optical system 32 and illumination optical system 5.

### EXAMPLE 2

In this example, one pupil has a transversal diameter of 15 mm and a vertical diameter of 10 mm. An image under observation is formed on an eyepiece optical system 32 located 400 mm forward of the pupil position and having a horizontal length of 55 mm and a vertical length of 41.25 mm. Left and right optical axes leave the eyepiece optical system 32 with an inward angle determined such that the left and right optical axes cross each other at a position 320 mm away from the pupil position on the side of the eyepiece optical system 32. For each of left and right image display devices 3L and 3R, an 8.94 mm×6.71 mm display device is used.

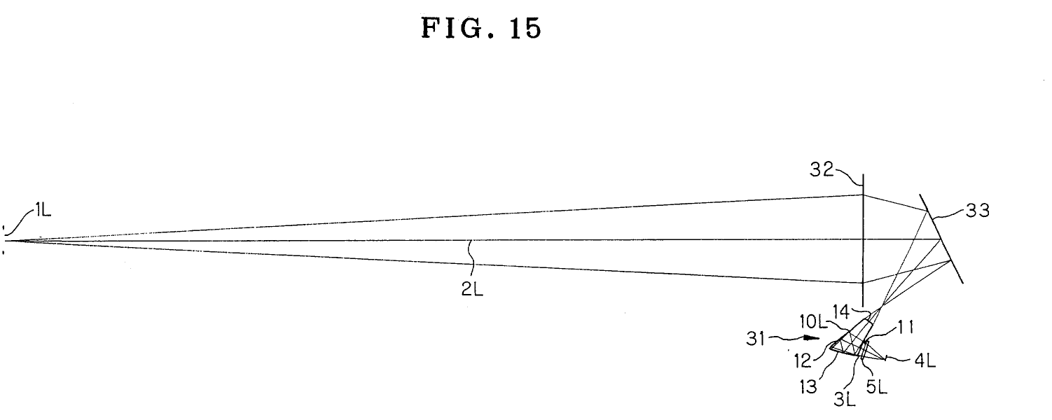

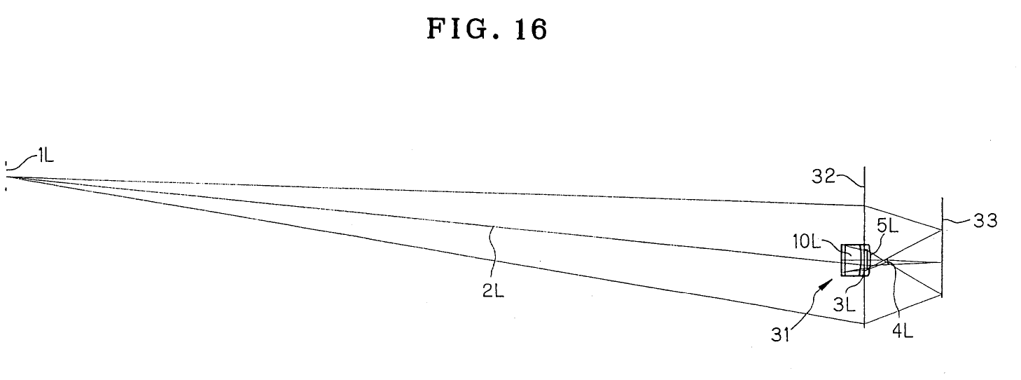

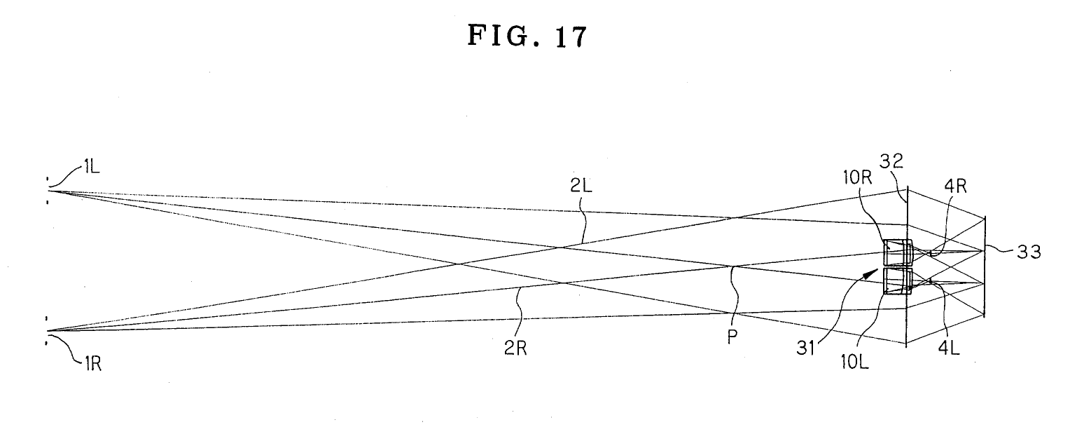

FIG. 15 is an optical path diagram as projected onto a Y-Z plane from one light source (the left illumination area at a reference position) 4L toward one exit pupil 1L; FIG. 16 is an optical path diagram as projected onto an X-Z plane; and FIG. 17 is an optical path diagram as projected onto the X-Z plane from both light sources 4L and 4R toward both exit pupils 1L and 1R.

Numerical data given later have been obtained by ray tracing from the left exit pupil 1L to one light source 4L via the image display device 3L, and data on the optical system upon ray tracing from the right exit pupil 1R to another light source 4R via the image display device 3R have been obtained at a position symmetrical with respect to the Y-Z plane of symmetry.

Example 2 is directed to an optical system dedicated to the binocular image display system corresponding to the embodiment of FIG. 4, as shown in FIGS. 15, 16 and 17. For a relay optical system 31, a pair of decentered prisms 10L and 10R that are symmetrical with respect to the Y-Z plane are used. Separate left and right image display devices 3L and 3R are located in opposition to the respective entrance surfaces 11 of the prisms 10L and 10R, and separate illumination optical systems 5L and 5R are provided to illuminate the respective image display devices.

The optical system in this example is shown in FIGS. 15, 16 and 17. An eyepiece optical system 32 that faces the exit pupils 1L and 1R is made up of a Fresnel lens whose surface on the side of the exit pupils 1L and 1R is a Fresnel transmitting surface and whose opposite surface is a plane. On the entrance side of the Fresnel lens, there is located a reflecting surface (plane mirror) 33 for turning back an optical path. In opposition to the reflecting surface 33, there is located a relay optical system 31 that is made up of a pair of decentered prisms 10L and 10R.

The decentered prisms 10L and 10R in this example are each made up of a first surface 11, a fourth surface 14 and two reflecting surfaces, i.e., a second surface 12 and a third surface 13. As described above, the decentered prisms 10L and 10R are each in a symmetrical form with the plane of symmetry (Y-Z plane) of the optical system. The first surfaces 11 face the image display devices 3L and 3R, and the fourth surfaces 14 face the reflecting surface 33. Both reflecting surfaces or the second and third surfaces 12 and 13 are interposed between the first surface 11 and the fourth surface 14.

The image display devices 3L and 3R are each made up of a transmission type liquid crystal display device. On the side of each image display device that faces away from the relay optical system 31, there is provided an illumination optical system 5L, 5R that is a Fresnel lens both surfaces of which are defined by Fresnel transmitting surfaces. These Fresnel lenses are positioned contiguously to the image display devices 3L and 3R, and near their front focal planes, light sources 4L and 4R are located at positions that are symmetrical with respect to the plane of symmetry (Y-Z plane). The light sources 4L and 4R for illuminating the left and right optical paths, respectively, are located at reference positions.

In the instant example, left-eye and right-eye images having binocular parallax are displayed on the left and right image display devices 3L and 3R, and illuminated by means of the left and right sources 4L and 4R via the left and right illumination optical systems 5L and 5R. Subsequently, the images of the left and right image display devices 3L and 3R are projected near the a common eyepiece optical system 32 through the left and right decentered prisms 10L and 10R, so that the left-eye and right-eye images having parallax can be displayed on the exit pupils 1L and 1R. The viewer can then bring his both eyes in line with the exit pupils 1L and 1R, thereby viewing 3D images.

More specifically, light beams from the light sources 4L and 4R enter the left and right illumination optical systems 5L and 5R. The light beams are then collimated through the Fresnel lenses into substantially parallel light beams to light the left and right image display devices 3L and 3R from behind. As already referred to, the image display devices 3L and 3R are each a transmission type liquid crystal display device; the light beams provide display light upon transmission through the image display devices 3L and 3R, traveling toward the decentered prisms 10L and 10R. Then, the light beams enter the decentered prisms 10L and 10R upon refraction at the first surfaces 11 thereof, in which they are subjected to repetitive internal reflections at the second surfaces 12 and the third surfaces 13. Then, the reflected light is refracted as separate light beams along the separate optical path at both surfaces 14L and 14R of each fourth surface 14, leaving the prism.

Both light beams leaving each decentered prism 10L, 10R are turned back at the reflecting surface 33, following which a magnified image is formed as a double image on the Fresnel lens surface of the eyepiece optical system 32. This magnified image provides the left-eye and right-eye images displayed on the image display devices 3L and 3R. Upon incidence on the eyepiece optical system 32, both light beams are refracted thereat, and then converged into the left and right exit pupils 1L and 1R, respectively (the light sources 4L and 4R are conjugate to the exit pupils 1L and 1R). In this case, the left and right optical paths 2L and 2R cross each other at a point P spaced 320 mm away from the positions of the exit pupils 1L and 1R toward the eyepiece optical system 32. For this reason, the magnified image formed on the Fresnel lens surface of the eyepiece optical system 32 is fused near this point P, so that images appearing on the image display devices 3L and 3R are seen as if they were three-dimensionally displayed in the air.

As explained with reference to FIGS. 1 and 2, the positions of the left and right eyeballs of the viewer are then detected by means of the eyeball position detector 40. In response to the detected information, the light sources 4L and 4R defining the left and right illumination areas of the light source 4 are so moved that the positions of the left and right exit pupils 1L and 1R can follow the eyeball positions of the viewer. Thus, it is possible for the viewer to view bright, shading-free images even with changes in the viewing position of the viewer. It is also possible to achieve a binocular image display system having reduced size and power consumption.

In this example, too, a lenticular sheet having diffusibility in the horizontal direction is further located near the plane (the third surface in the numerical data) of the eyepiece optical system 32, so that the pupils can be enlarged in the horizontal direction alone and, hence, a much wider viewing range can be assured. Even with some displacement of the eyeballs of the viewer, it is possible for the viewer to observe bright, shading-free images if the eyeballs are within this viewing range.

In this example, free-form surfaces are used for all the first surface 11 through the fourth surface 14 of each decentered prism 10L, 10R, and an aspheric surface is used for the Fresnel transmitting surface of each of the Fresnel lenses of the eyepiece optical system 32 and illumination optical system 5.

### EXAMPLE 3

In this example, one pupil has a diameter of 10 mm. An image under observation is formed on an eyepiece optical system 32 located 400 mm forward of a pupil position and having a horizontal length of 55 mm and a vertical length of 41.25 mm. Left and right optical axes leave the eyepiece optical system with an inward angle determined such that the left and right optical axes cross each other at a position 320 mm away from the pupil position on the side of the eyepiece optical system 32. For the image display device 3, an 8.94 mm×6.71 mm display device is used.

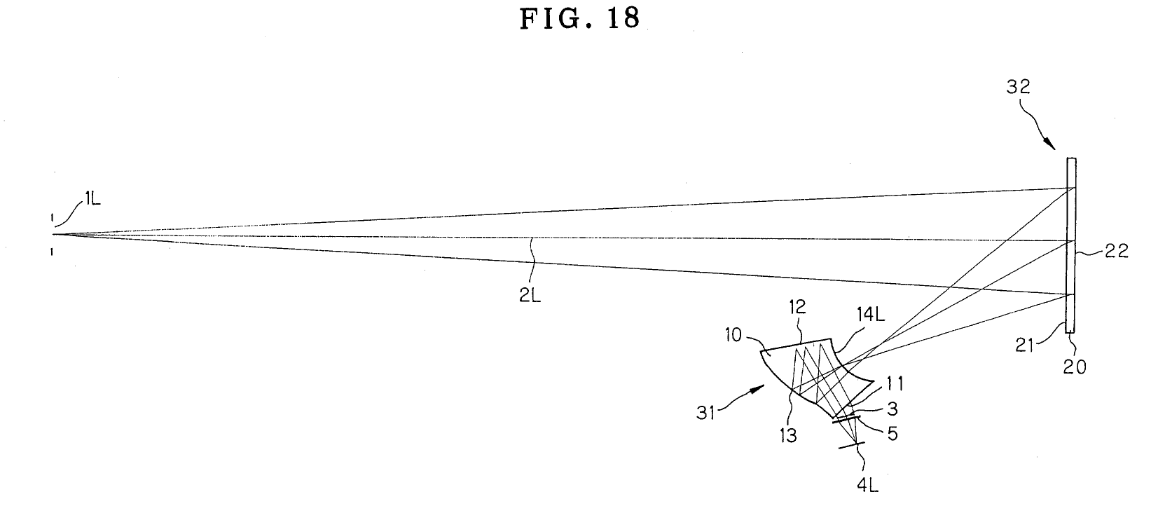

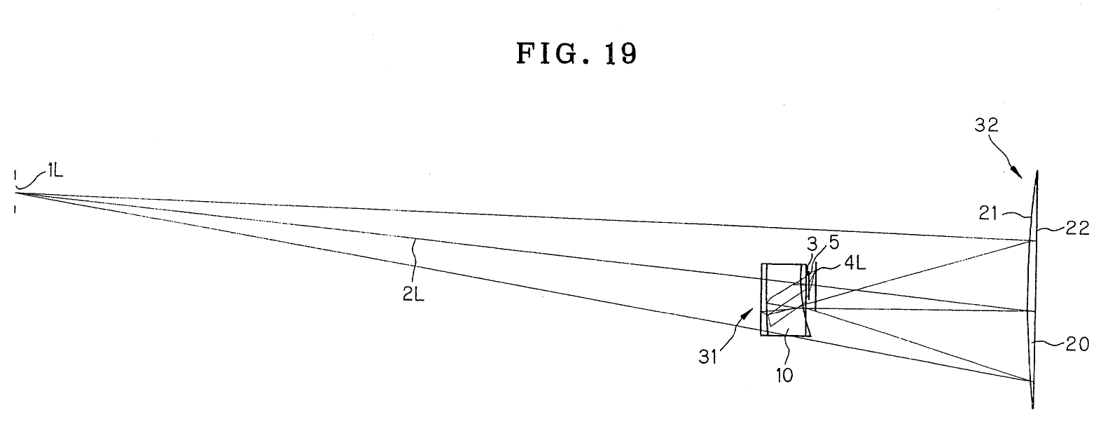

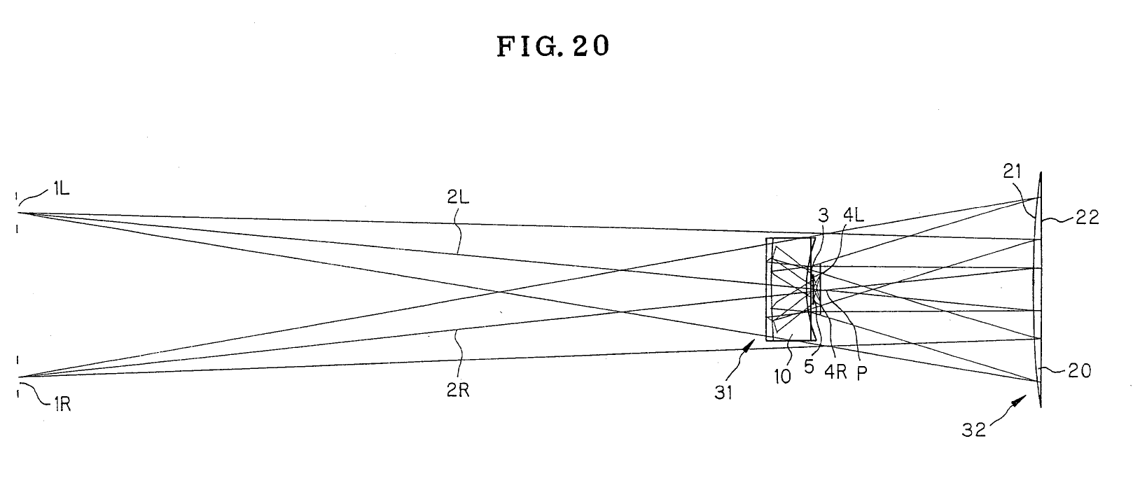

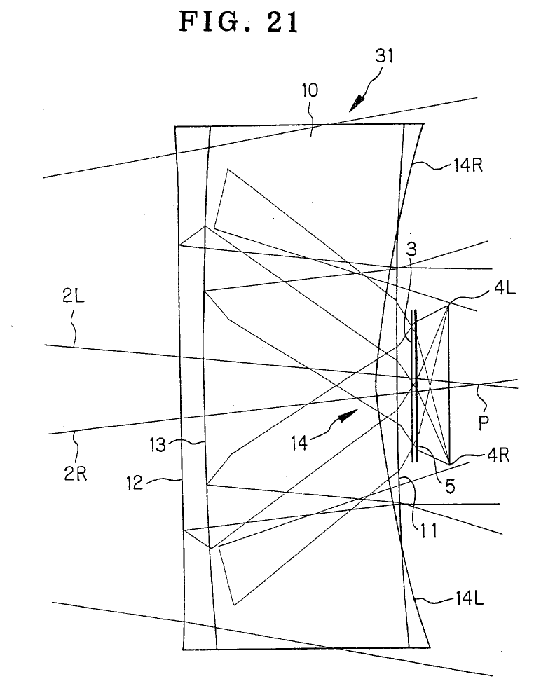

FIG. 18 is an optical path diagram as projected onto a Y-Z plane from one light source (the left illumination area at a reference position) 4L toward one exit pupil 1L; FIG. 19 is an optical path diagram as projected onto an X-Z plane; FIG. 20 is an optical path diagram as projected onto the X-Z plane from both light sources 4L and 4R toward both exit pupils 1L and 1R; and FIG. 21 is an enlarged view of the vicinities of light sources 4L, 4R, illumination optical system 5, image display device 3 and decentered prism 10 of relay optical system 31 in FIG. 20.

Numerical data given later have been obtained by ray tracing from the left exit pupil 1L to one light source 4L via the image display device 3, and data on the optical system upon ray tracing from the right exit pupil 1R to another light source 4R via the image display device 3 have been obtained at a position symmetric with respect to the Y-Z plane of symmetry.

In Example 3, the eyepiece optical system 32 is made up of a Fresnel reflecting mirror 20 whose surface on the side of the exit pupil 1L (1R) is a free-form transmitting surface 21 and whose opposite surface is a Fresnel reflecting surface 22, whereby the optical path turning-back reflecting mirror 33 can be dispensed with. A decentered prism 10 forms a relay optical system 31. The fourth surface 14 of this decentered prism 10 (the fifth surface in the numerical data) comprises a discontinuous surface symmetrical with respect to the Y-Z plane of symmetry. Only the surface shape of one surface 14L is shown. This surface 14L takes part in the formation of a left exit pupil 1L, and is located on the negative side of an X-axis with respect to the Y-Z plane. On the positive side of the X-axis with respect to the Y-Z plane, there is located another surface 14R that is symmetrical with respect to the surface 14L (see FIG. 21).

In this example, the fourth surface 14 is thus formed as a discontinuous surface made up of two optical surfaces 14L and 14R symmetrical with respect to the plane of symmetry, thereby setting up an optical system that forms at given positions left and right exit pupils 1L and 1R, each having a diameter of 10 mm. These given positions are mutually spaced 75 mm from the plane of symmetry (Y-Z plane) of the optical system in this example.

The optical system in Example 3 is shown in FIGS. 18, 19, 20 and 21. Here the eyepiece optical system 32 that faces the exit pupil 1L (1R) is defined by the Fresnel reflecting mirror 20 whose surface on the side of the exit pupil 1L (1R) is the free-form transmitting surface 21 and whose opposite surface is the Fresnel reflecting surface 22. In opposition to this reflecting mirror, there is located a relay optical system 31 that is made up of a decentered prism 10 that faces the image display device 3. The decentered prism 10 in this example is made up of a first surface 11, a fourth surface 14 and two reflecting surfaces, i.e., a second surface 12 and a third surface 13. The first surface 11 faces the image display device 3, and the fourth surface 14 faces the Fresnel reflecting mirror 20. Both reflecting surfaces or the second and third surfaces 12 and 13 are interposed between the first surface 11 and the fourth surface 14. As described above, the fourth surface 14 is built up of two surfaces 14L and 14R that form together a discontinuous surface, and is symmetrical with respect to the symmetrical plane (Y-Z plane) of the optical system.

The image display device 3 is made up of a transmission type liquid crystal display device. On the side of the image display device 3 that faces away from the relay optical system 31, there is provided an illumination optical system 5 that is a Fresnel lens both surfaces of which are defined by Fresnel transmitting surfaces. This Fresnel lens is positioned near the image display device 3, and in the vicinity of its front focal plane, light sources 4L and 4R are located at positions that are symmetrical with respect to the plane of symmetry (Y-Z plane). The light sources 4L and 4R for illuminating the left and right optical paths, respectively, are located at reference positions.

In the instant example, left-eye and right-eye images having binocular parallax are alternately displayed on the image display device 3. The light sources 4L and 4R for the left and right optical paths are selectively put on in synchronism with the alternate display of those images, so that the left-eye and right-eye images having parallax can be displayed on the exit pupils 1L and 1R in a time-division fashion. The viewer can then bring his both eyes in line with the exit pupils 1L and 1R, thereby viewing 3D images.

More specifically, light beams from the light sources 4L and 4R enter the illumination optical system 5. The light beams are then collimated through the Fresnel lens into a substantially parallel light beam to light the image display device 3 from behind. As already referred to, the image display device 3 is a transmission type liquid crystal display device; the light beam provides display light upon transmission through the image display device 3, traveling toward the decentered prism 10. Then, the light beam enters the decentered prism 10 upon refraction at the first surface 11 thereof, in which it is subjected to repetitive internal reflections at the second surface 12 and the third surface 13. Then, the reflected light is refracted as separate light beams along the separate optical path at both surfaces 14L and 14R of the fourth surface 14, leaving the prism.

Both light beams leaving the decentered prism 10 enter the Fresnel reflecting mirror 20 of the eyepiece optical system 32 to form a magnified image as a double image on the transmitting surface 21 thereof. Upon incidence on the eyepiece optical system 32, both light beams are reflected thereat, and then converged into the left and right exit pupils 1L and 1R, respectively (the light sources 4L and 4R are conjugate to the exit pupils 1L and 1R). In this case, the left and right optical paths 2L and 2R cross each other at a point P spaced 320 mm away from the positions of the exit pupils 1L and 1R toward the eyepiece optical system 32. For this reason, the magnified image formed on the Fresnel lens surface of the eyepiece optical system 32 is fused near this point P, so that an image appearing on the image display device 3 is seen as if it were three-dimensionally displayed in the air.

As explained with reference to FIGS. 1 and 2, the positions of the left and right eyeballs of the viewer are then detected by means of the eyeball position detector 40. In response to the detected information, the light sources 4L and 4R defining the left and right illumination areas of the light source 4 are so moved that the positions of the left and right exit pupils 1L and 1R can follow the eyeball positions of the viewer. Thus, it is possible for the viewer to view bright, shading-free images even with changes in the viewing position of the viewer. It is also possible to achieve a binocular image display system having a limited number of components and reduced in terms of size and power consumption.

In this example, free-form surfaces are used for all the first surface 11 through the fourth surface 14 of the decentered prism 10 as well as for the transmitting surface 21 of the Fresnel reflecting mirror 20. An aspheric surface is used for the Fresnel reflecting surface 22 of the Frensel reflecting mirror 20, and the Fresnel transmitting surface of the Fresnel lens that forms the illumination optical system 5.

Numerical data on each example are now enumerated below. In what follows, “FFS”, “ASS”, “RE”, “FR”, “LCD” and “EIM” stand for a free-form surface, an aspheric surface, a reflecting surface, a Fresnel surface, an image display screen surface and an image-formation surface, respectively.

### Example 1

| | | | Dis- | | |
|---|---|---|---|---|---|
| Surface | Radius of | Surface | placement | Refractive | Abbe's |
| No. | curvature | separation | and tilt | index | No. |
| Object | ∞ (Exit pupil) | | (1) | | |
| plane | | | | | |
| 1 | ∞ (EIM) | | (2) | | |
| 2 | ASS\mathring{1} (FR) | | (3) | 1.4917 | 55.3 |
| 3 | ∞ | | (4) | | |
| 4 | ∞ (RE) | | (5) | | |
| 5 | FFS\mathring{1} | | (6) | 1.5254 | 56.2 |
| 6 | FFS\mathring{2} (RE) | | (7) | 1.5254 | 56.2 |
| 7 | FFS\mathring{3} (RE) | | (8) | 1.5254 | 56.2 |
| 8 | FFS\mathring{4} | | (9) | | |
| 9 | ∞ (LCD) | | (10) | | |
| 10 | ASS\mathring{2} (FR) | | (11) | 1.4922 | 57.5 |
| 11 | ASS\mathring{3} (FR) | | (12) | | |
| Image | ∞ (Light source) | | (13) | | |
| plane | | | | | |

ASS1

| | |
|---|---|
| R | 31.96 |
| K | −8.8437 × 10⁻¹ |
| A | −2.0647 × 10⁻⁷ |
| B | −3.0494 × 10⁻¹¹ |
| C | −2.1945 × 10⁻¹⁴ |
| D | 8.5889 × 10⁻¹⁸ |

ASS2

| | |
|---|---|
| R | −9.34 |
| K | 1.5548 |
| A | −2.5478 × 10⁻³ |
| B | 1.6810 × 10⁻⁴ |

ASS3

| | |
|---|---|
| R | 415.54 |
| K | 0.0000 |
| A | −2.4090 × 10⁻³ |
| B | 1.4360 × 10⁻⁴ |

FFS1

| | | | | | |
|---|---|---|---|---|---|
| C₄ | −1.9759 × 10⁻² | C₆ | −1.5486 × 10⁻² | C₈ | 7.8535 × 10⁻⁴ |
| C₁₀ | −5.3236 × 10⁻⁴ | | | | |

FFS2

| | | | | | |
|---|---|---|---|---|---|
| C₄ | 5.3042 × 10⁻³ | C₆ | 9.1563 × 10⁻³ | C₈ | 6.6168 × 10⁻⁵ |
| C₁₀ | 1.4210 × 10⁻⁴ | C₁₁ | −2.5602 × 10⁻⁶ | C₁₃ | −3.0241 × 10⁻⁷ |
| C₁₅ | −3.4168 × 10⁻⁶ | | | | |

FFS3

| | | | | | |
|---|---|---|---|---|---|
| C₄ | −9.4857 × 10⁻³ | C₆ | −2.3802 × 10⁻⁵ | C₈ | 2.0566 × 10⁻⁴ |
| C₁₀ | 4.1823 × 10⁻⁴ | C₁₁ | −1.8450 × 10⁻⁶ | C₁₃ | 2.4666 × 10⁻⁷ |
| C₁₅ | −4.1469 × 10⁻⁶ | | | | |

FFS4

| | | | | | |
|---|---|---|---|---|---|
| C₄ | 3.4019 × 10⁻⁴ | C₆ | 1.8625 × 10⁻² | C₈ | −6.6385 × 10⁻⁴ |
| C₁₀ | −4.1792 × 10⁻⁴ | C₁₃ | −4.9648 × 10⁻⁴ | | |

Displacement and tilt(1)

| | | | | | |
|---|---|---|---|---|---|
| X | 32.50 | Y | 0.00 | Z | −400.00 |
| α | 0.00 | β | 0.00 | γ | 0.00 |

Displacement and tilt(2)

| | | | | | |
|---|---|---|---|---|---|
| X | −8.13 | Y | 0.00 | Z | 0.00 |
| α | 0.00 | β | 0.00 | γ | 0.00 |

Displacement and tilt(3)

| | | | | | |
|---|---|---|---|---|---|
| X | 0.00 | Y | 0.00 | Z | 0.00 |
| α | 0.00 | β | 0.00 | γ | 0.00 |

Displacement and tilt(4)

| | | | | | |
|---|---|---|---|---|---|
| X | 0.00 | Y | 0.00 | Z | 1.00 |
| α | 0.00 | β | 0.00 | γ | 0.00 |

Displacement and tilt(5)

| | | | | | |
|---|---|---|---|---|---|
| X | 0.00 | Y | 0.00 | Z | 35.00 |
| α | 25.00 | β | 0.00 | γ | 0.00 |

Displacement and tilt(6)

| | | | | | |
|---|---|---|---|---|---|
| X | −6.11 | Y | −34.06 | Z | 6.42 |
| α | 68.88 | β | 6.76 | γ | 0.00 |

Displacement and tilt(7)

| | | | | | |
|---|---|---|---|---|---|
| X | 0.00 | Y | −44.88 | Z | −0.62 |
| α | 87.54 | β | 0.00 | γ | 0.00 |

Displacement and tilt(8)

| | | | | | |
|---|---|---|---|---|---|
| X | 0.00 | Y | −38.48 | Z | −4.10 |
| α | 142.30 | β | 0.00 | γ | 0.00 |

Displacement and tilt(9)

| | | | | | |
|---|---|---|---|---|---|
| X | 0.00 | Y | −41.11 | Z | 6.52 |
| α | 165.58 | β | 0.00 | γ | 0.00 |

Displacement and tilt(10)

| | | | | | |
|---|---|---|---|---|---|
| X | 0.00 | Y | −41.51 | Z | 8.25 |
| α | 162.10 | β | 0.00 | γ | 180.00 |

Displacement and tilt(11)

| | | | | | |
|---|---|---|---|---|---|
| X | 0.00 | Y | −41.82 | Z | 9.20 |
| α | 162.10 | β | 0.00 | γ | 180.00 |

Displacement and tilt(12)

| | | | | | |
|---|---|---|---|---|---|
| X | 0.00 | Y | −41.98 | Z | 9.68 |
| α | 162.10 | β | 0.00 | γ | 180.00 |

Displacement and tilt(13)

| | | | | | |
|---|---|---|---|---|---|
| X | 5.36 | Y | −45.05 | Z | 19.19 |
| α | 162.10 | β | 0.00 | γ | 180.00 |

### Example 2

| | | | Dis- | | |
|---|---|---|---|---|---|
| Surface | Radius of | Surface | placement | Refractive | Abbe's |
| No. | curvature | separation | and tilt | index | No. |
| Object | ∞ (Exit pupil) | | (1) | | |
| plane | | | | | |
| 1 | ∞ (EIM) | | (2) | | |
| 2 | ASS\mathring{1} (FR) | | (3) | 1.4917 | 55.3 |
| 3 | ∞ | | (3) | | |
| 4 | ∞ (RE) | | (4) | | |
| 5 | FFS\mathring{1} | | (5) | 1.5254 | 56.2 |
| 6 | FFS\mathring{2} (RE) | | (6) | 1.5254 | 56.2 |
| 7 | FFS\mathring{3} (RE) | | (8) | 1.5254 | 56.2 |
| 8 | FFS\mathring{4} | | (8) | | |
| 9 | ∞ (LCD) | | (9) | | |
| 10 | ASS\mathring{2} (FR) | | (9) | 1.4922 | 57.5 |
| 11 | ASS\mathring{3} (FR) | | (10) | | |
| Image | ∞ (Light source) | | (11) | | |
| plane | | | | | |

ASS1

| | |
|---|---|
| R | 31.96 |
| K | −8.8437 × 10⁻¹ |
| A | −2.0647 × 10⁻⁷ |
| B | −3.0494 × 10⁻¹¹ |
| C | −2.1945 × 10⁻¹⁴ |
| D | 8.5889 × 10⁻¹⁸ |

ASS2

| | |
|---|---|
| R | 7.53 |
| K | 1.1355 |
| A | 7.3230 × 10⁻⁶ |
| B | −1.8136 × 10⁻⁵ |

ASS3

| | |
|---|---|
| R | 6.57 |
| K | 0.0000 |

FFS1

| | | | | | |
|---|---|---|---|---|---|
| C₄ | −2.4933 × 10⁻² | C₆ | −2.1301 × 10⁻² | C₈ | 3.0650 × 10⁻⁴ |
| C₁₀ | −3.4063 × 10⁻⁴ | | | | |

FFS2

| | | | | | |
|---|---|---|---|---|---|
| C₄ | 7.6618 × 10⁻³ | C₆ | 7.3910 × 10⁻³ | C₈ | −5.6862 × 10⁻⁵ |
| C₁₀ | 7.7711 × 10⁻⁶ | C₁₁ | −3.6130 × 10⁻⁶ | C₁₃ | −1.0071 × 10⁻⁵ |
| C₁₅ | 3.6323 × 10⁻⁶ | | | | |

FFS3

| | | | | | |
|---|---|---|---|---|---|
| C₄ | −7.8282 × 10⁻³ | C₆ | −5.6025 × 10⁻³ | C₈ | 1.1900 × 10⁻⁴ |
| C₁₀ | 1.5724 × 10⁻⁴ | C₁₁ | 1.1767 × 10⁻⁵ | C₁₃ | −1.1134 × 10⁻⁸ |
| C₁₅ | 6.3433 × 10⁻⁶ | | | | |

FFS4

| | | | | | |
|---|---|---|---|---|---|
| C₄ | 1.4646 × 10⁻² | C₆ | 2.9726 × 10⁻³ | C₈ | 2.4081 × 10⁻³ |
| C₁₀ | 1.2081 × 10⁻³ | C₁₃ | −3.5528 × 10⁻⁴ | | |

Displacement and tilt(1)

| | | | | | |
|---|---|---|---|---|---|
| X | 32.50 | Y | 0.00 | Z | −400.00 |
| α | 0.00 | β | 0.00 | γ | 0.00 |

Displacement and tilt(2)

| | | | | | |
|---|---|---|---|---|---|
| X | −8.13 | Y | 0.00 | Z | 0.00 |
| α | 0.00 | β | 0.00 | γ | 0.00 |

Displacement and tilt(3)

| | | | | | |
|---|---|---|---|---|---|
| X | 0.00 | Y | 0.00 | Z | 0.00 |
| α | 0.00 | β | 0.00 | γ | 0.00 |

Displacement and tilt(4)

| | | | | | |
|---|---|---|---|---|---|
| X | 0.00 | Y | 0.00 | Z | 35.00 |
| α | 25.00 | β | 0.00 | γ | 0.00 |

Displacement and tilt(5)

| | | | | | |
|---|---|---|---|---|---|
| X | −6.20 | Y | −38.61 | Z | 2.60 |
| α | 53.41 | β | 1.46 | γ | −0.09 |

Displacement and tilt(6)

| | | | | | |
|---|---|---|---|---|---|
| X | −5.73 | Y | −53.07 | Z | −9.04 |
| α | 76.70 | β | 1.30 | γ | −0.66 |

Displacement and tilt(7)

| | | | | | |
|---|---|---|---|---|---|
| X | −5.83 | Y | −46.93 | Z | −10.37 |
| α | 129.12 | β | 0.28 | γ | −1.43 |

Displacement and tilt(8)

| | | | | | |
|---|---|---|---|---|---|
| X | −5.89 | Y | −50.90 | Z | −1.44 |
| α | 160.17 | β | −0.50 | γ | −1.37 |

Displacement and tilt(9)

| | | | | | |
|---|---|---|---|---|---|
| X | −5.91 | Y | −51.78 | Z | 0.36 |
| α | 160.04 | β | −0.50 | γ | 178.63 |

Displacement and tilt(10)

| | | | | | |
|---|---|---|---|---|---|
| X | −5.91 | Y | −52.12 | Z | 1.30 |
| α | 160.04 | β | −0.50 | γ | 178.63 |

Displacement and tilt(11)

| | | | | | |
|---|---|---|---|---|---|
| X | −6.00 | Y | −55.54 | Z | 10.70 |
| α | 160.04 | β | −0.50 | γ | 178.63 |

### Example 3

| | | | Dis- | | |
|---|---|---|---|---|---|
| Surface | Radius of | Surface | placement | Refractive | Abbe's |
| No. | curvature | separation | and tilt | index | No. |
| Object | ∞ (Exit pupil) | | (1) | | |
| plane | | | | | |
| 1 | ∞ (EIM) | | (2) | | |
| 2 | FFS\mathring{1} | | (3) | 1.5254 | 56.2 |
| 3 | ASS\mathring{1} (FR, RE) | | (4) | 1.5254 | 56.2 |
| 4 | FFS\mathring{1} | | (3) | | |
| 5 | FFS\mathring{2} | | (5) | 1.5254 | 56.2 |
| 6 | FFS\mathring{3} (RE) | | (6) | 1.5254 | 56.2 |
| 7 | FFS\mathring{4} (RE) | | (7) | 1.5254 | 56.2 |
| 8 | FFS\mathring{5} | | (8) | | |
| 9 | ∞ (LCD) | | (9) | | |
| 10 | ASS\mathring{2} (FR) | | (10) | 1.4922 | 57.5 |
| 11 | ASS\mathring{3} (FR) | | (11) | | |
| Image | ∞ (Light source) | | (12) | | |
| plane | | | | | |

ASS1

| | |
|---|---|
| R | −607.47 |
| K | 0.0000 |
| A | −1.6044 × 10⁻⁷ |
| B | 1.5624 × 10⁻¹¹ |
| C | −5.4150 × 10⁻¹⁶ |

ASS2

| | |
|---|---|
| R | −10.63 |
| K | 0.0000 |
| A | −1.2717 × 10⁻³ |
| B | 1.3925 × 10⁻⁵ |

ASS3

| | |
|---|---|
| R | 55.43 |
| K | 0.0000 |
| A | −1.1411 × 10⁻³ |
| B | −1.1394 × 10⁻⁶ |

FFS1

| | | | | | |
|---|---|---|---|---|---|
| C₄ | 1.2387 × 10⁻³ | C₆ | 2.0875 × 10⁻⁵ | C₈ | −2.0915 × 10⁻⁵ |
| C₁₀ | 2.0673 × 10⁻⁶ | C₁₁ | 1.0786 × 10⁻⁸ | C₁₃ | 3.1805 × 10⁻⁷ |

FFS2

| | | | | | |
|---|---|---|---|---|---|
| C₄ | 6.1023 × 10⁻³ | C₆ | 3.4205 × 10⁻² | C₈ | 8.2185 × 10⁻⁵ |
| C₁₁ | 9.6476 × 10⁻⁶ | C₁₃ | −3.8644 × 10⁻⁵ | | |

FFS3

| | | | | | |
|---|---|---|---|---|---|
| C₄ | 1.1628 × 10⁻³ | C₆ | 8.8659 × 10⁻³ | C₈ | −1.2017 × 10⁻⁴ |
| C₁₀ | −1.9464 × 10⁻⁵ | C₁₁ | −3.7097 × 10⁻⁶ | C₁₃ | −7.1219 × 10⁻⁶ |
| C₁₅ | 2.8841 × 10⁻⁷ | | | | |

FFS4

| | | | | | |
|---|---|---|---|---|---|
| C₄ | −8.8189 × 10⁻³ | C₆ | −3.7330 × 10⁻⁴ | C₈ | −1.3608 × 10⁻⁴ |
| C₁₀ | −4.4468 × 10⁻⁵ | C₁₁ | −1.6606 × 10⁻⁶ | C₁₃ | −7.8869 × 10⁻⁶ |
| C₁₅ | 1.8628 × 10⁻⁶ | | | | |

FFS5

| | | | | | |
|---|---|---|---|---|---|
| C₄ | −9.3026 × 10⁻⁴ | C₆ | −2.1612 × 10⁻³ | C₈ | 1.4866 × 10⁻³ |
| C₁₁ | −4.2093 × 10⁻⁶ | C₁₃ | −9.1193 × 10⁻⁵ | | |

Displacement and tilt(1)

| | | | | | |
|---|---|---|---|---|---|
| X | 32.50 | Y | 0.00 | Z | −400.00 |
| α | 0.00 | β | 0.00 | γ | 0.00 |

Displacement and tilt(2)

| | | | | | |
|---|---|---|---|---|---|
| X | −8.13 | Y | 0.00 | Z | 0.00 |
| α | 0.00 | β | 0.00 | γ | 0.00 |

Displacement and tilt(3)

| | | | | | |
|---|---|---|---|---|---|
| X | 0.00 | Y | 0.00 | Z | 0.00 |
| α | 0.00 | β | 0.00 | γ | 0.00 |

Displacement and tilt(4)

| | | | | | |
|---|---|---|---|---|---|
| X | 0.00 | Y | −57.15 | Z | 3.00 |
| α | 0.00 | β | 0.00 | γ | 0.00 |

Displacement and tilt(5)

| | | | | | |
|---|---|---|---|---|---|
| X | −9.01 | Y | −50.00 | Z | −86.60 |
| α | 41.96 | β | −13.88 | γ | 0.00 |

Displacement and tilt(6)

| | | | | | |
|---|---|---|---|---|---|
| X | 0.00 | Y | −61.18 | Z | −103.26 |
| α | 57.94 | β | 0.00 | γ | 0.00 |

Displacement and tilt(7)

| | | | | | |
|---|---|---|---|---|---|
| X | 0.00 | Y | −40.96 | Z | −101.39 |
| α | 100.79 | β | 0.00 | γ | 0.00 |

Displacement and tilt(8)

| | | | | | |
|---|---|---|---|---|---|
| X | 0.00 | Y | −66.86 | Z | −86.14 |
| α | 133.89 | β | 0.00 | γ | 0.00 |

Displacement and tilt(9)

| | | | | | |
|---|---|---|---|---|---|
| X | 0.00 | Y | −69.64 | Z | −84.97 |
| α | 104.41 | β | 0.00 | γ | 0.00 |

Displacement and tilt(10)

| | | | | | |
|---|---|---|---|---|---|
| X | 0.00 | Y | −70.61 | Z | −84.72 |
| α | 104.41 | β | 0.00 | γ | 0.00 |

Displacement and tilt(11)

| | | | | | |
|---|---|---|---|---|---|
| X | 0.00 | Y | −71.10 | Z | −84.59 |
| α | 104.41 | β | 0.00 | γ | 0.00 |

Displacement and tilt(12)

| | | | | | |
|---|---|---|---|---|---|
| X | 6.29 | Y | −80.78 | Z | −82.11 |
| α | 104.41 | β | 0.00 | γ | 0.00 |

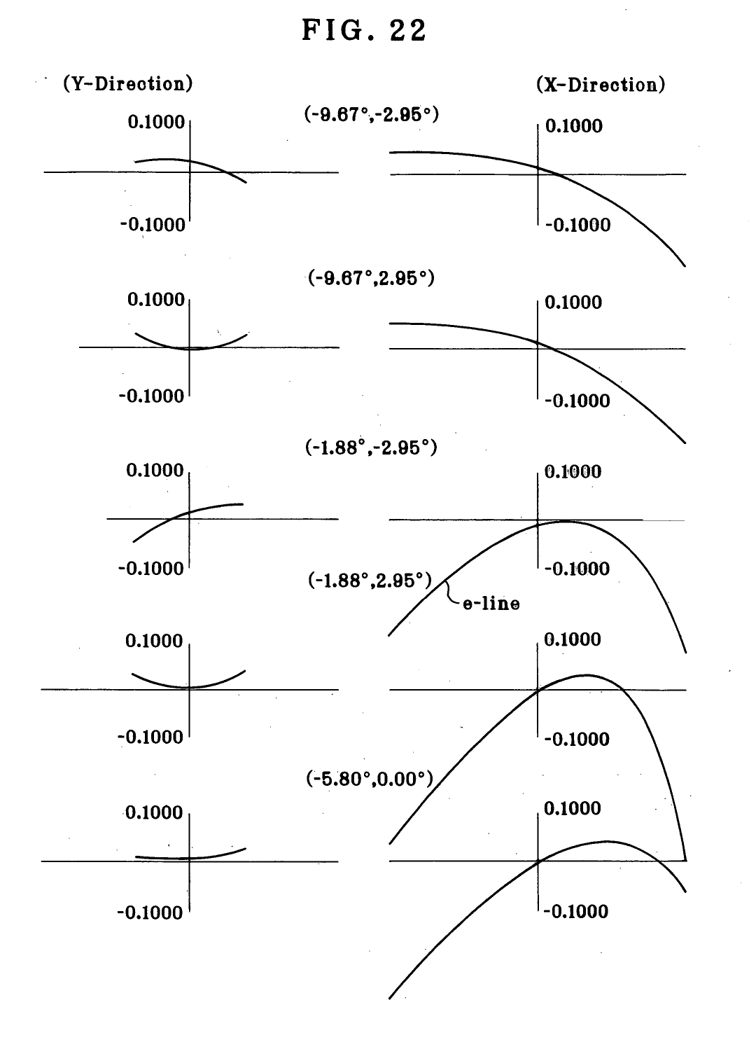

Transverse aberrations for one optical system in Example 1 are shown in FIG. 22, wherein the bracketed figures stand for horizontal and vertical angles of view, at which transverse aberrations are measured.

In any one of the three examples, the transmission type liquid crystal display device is used as the image display device 3, 3L, 3R. However, the present invention is not limited to such an image display device. Instead, a reflection type image display device such as a reflection type liquid crystal display device or a DMD (digital micro-mirror device) could be used. With these devices, an image display system capable of viewing 3D images in smaller, more compact construction and lower power consumptions could be achieved, as shown typically shown in FIG. 5. That is, illumination is carried out via a part or the whole of the decentered prism (10, 10L, 10R) forming the relay optical system 31. For instance, illumination light from the left and right illumination areas 4L and 4R of the illumination light source 4 is directed to the display screen surface of the reflection type image display device 3 via the decentered prism. Then, display light modulated at the display screen surface is reentered into the decentered prism, so that the image appearing on the reflection type image display device can be projected along the optical axes 2L and 2R leading to the left and right exit pupils 1L and 1R.

Referring here to the eyeball position detector 40 that is operable to detect the positions of the left and right eyeballs of the viewer, the illumination areas 4L and 4R of the illumination light source 4 are arbitrarily moved in response to the detected information. For the illumination light source 4, a two-dimensional array of LEDs, a two-dimensional organic EL, a transmission type liquid crystal display device illuminated by a backlight, etc. could be used.

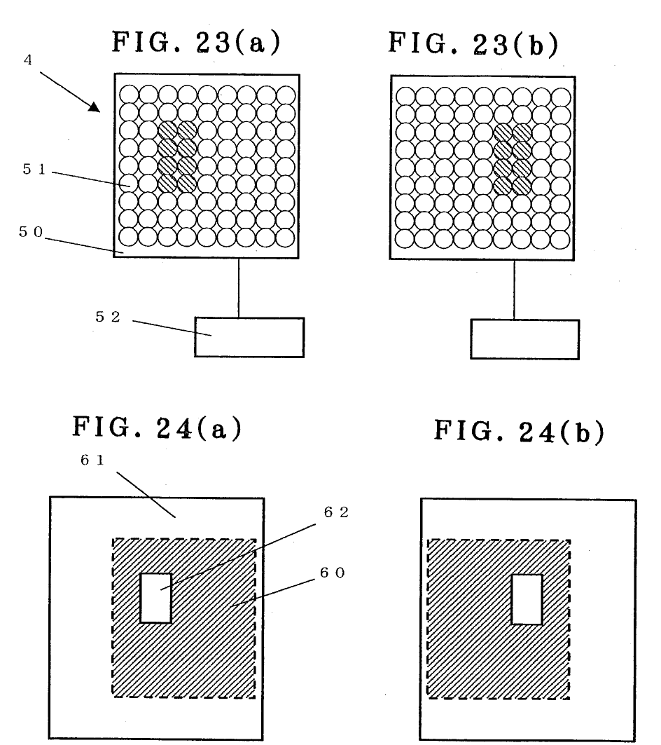

FIGS. 23(a) and 23(b) are illustrative of one exemplary light source 4 using a two-dimensional array of LEDs, wherein LEDs 51 are two-dimensionally arrayed. This LED array is connected to a control circuit 52, so that which LED is used to emit light is selected depending on control signals from the control circuit 52. FIG. 23(a) is illustrative of how LEDs located from the center to left area emit light, and FIG. 23(b) is illustrative of how LEDs located from the center to right area give out light.

Besides, the light source could comprise a surface light source with a pair of apertures located in front thereof or a pair of mechanically movable point light sources, as shown in FIGS. 24(a) and 24(b) wherein a surface light source is used as a light source 60 and an aperture member 61 is located on its light-emitting surface. The aperture member 61 is formed of a material opaque to light, and partly provided with an aperture 62. By movement of the aperture member 61 relative to the light source 60, it is thus possible to vary the light-emitting area. FIG. 24(a) is illustrative of how the center to left area emits light, and FIG. 24(b) is illustrative of how the center to right area gives out light.

It is noted that the illumination areas 4L and 4R are movable in the range where light rays are not shaded by the relay optical system 31 and eyepiece optical system 32.

The decentered prism optical system used for the relay optical system is not limited to those of the type used in Examples 1, 2 and 3. For instance, decentered prisms of other types could be used alone or in combination.

1. A binocular image display system, comprising in combination:
an image display device for displaying an image,
an illumination light source for generating illumination light, wherein said illumination light source comprises a plurality of illumination areas provided in such a way as to be variable,
an illumination optical system for directing illumination light from said illumination light source toward said image display device,
a relay optical system for projection of an image appearing on said image display device,
an eyepiece optical system for converging a light beam from said relay optical system at a given position,
an eyeball position detector for detecting the positions of both eyeballs of a viewer, said eyepiece optical system comprising one member operable to converge all light rays from said relay optical system to said both eyeballs, and
a control unit for varying said illumination areas based on information on the positions of both eyeballs of a viewer detected by said detector.

2. The binocular image display system according to claim 1, wherein:
said relay optical system forms said image near said eyepiece optical system.

3. (cancelled)

4. A binocular image display system, comprising in combination:
an image display device for displaying an image,
an illumination light source for generating illumination light, wherein said illumination light source comprises a plurality of illumination areas provided in such a way as to be variable,
an illumination optical system for directing illumination light from said illumination light source toward said image display device,
a relay optical system for projection of an image appearing on said image display device,
an eyepiece optical system for converging a light beam from said relay optical system at a given position.
an eyeball position detector for detecting the positions of both eyeballs of a viewer, and
a control unit for varying said illumination areas based on information on the positions of both eyeballs of a viewer detected by said detector, wherein:
said relay optical system comprises a prism formed of a medium having a refractive index of n>1, wherein said prism comprises an optical surface through which a light beam enters the prism, at least one optical surface for reflecting the light beam in the prism and an optical surface through which the light beam leaves the prism,
at least one of said optical surfaces being a rotationally asymmetric surface, and
one of said optical surfaces includes at least two adjoining surfaces, wherein one surface of said adjoining surfaces is positioned in one optical path of two optical paths running to said both eyeballs, and another surface of said adjoining surfaces is positioned in another optical path of said two optical paths.

5. The binocular image display system according to claim 1, wherein:
said image display device is a reflection type image display device, and
illumination light form said illumination light source is directed to said reflection type image display device via said relay optical system.

6. The binocular image display device according to claim 1, wherein:
said image display device is a transmission type image display device.

7. The binocular image display device according to claim 1, wherein:
said illumination light source comprises a surface light source having an illumination area settable as desired.

8. The binocular image display system according to claim 7, wherein:
said illumination light source comprises in combination:
a single surface light source, and
an aperture member having an aperture having an area smaller than that of said surface light source, wherein said aperture member is located proximately to said illumination light source.

9. The binocular image display system according to claim 7, wherein:
said illumination light source comprises:
a plurality of minute light sources that are arranged in an array form, and
a control circuit for controlling turning-on or turning-off of said minute light sources.

10. The binocular image display system according to claim 1, wherein:
said image display device is a single image display device for alternately displaying a left-eye image and a right-eye image.

11. The binocular image display system according to claim 1, wherein:
said image display device comprises a pair of image display devices for displaying a left-eye image and a right-eye image.
